(19) United States
(12) Patent Application Publication
(10) Pub. No.: US 2016/0241536 A1
(43) Pub. Date: Aug. 18, 2016

(54) SYSTEM AND METHODS FOR USER AUTHENTICATION ACROSS MULTIPLE DOMAINS

(71) Applicant: WePay, Inc., Palo Alto, CA (US)

(72) Inventors: Ryan Parman, Santa Clara, CA (US); Andrew LeBlanc, Austin, TX (US); Amy Lin, Palo Alto, CA (US); Craig Lee Zarmer, Mountain View, CA (US); Facundo Ramos, San Francisco, CA (US); Vasusen Patil, Mountain View, CA (US)

(21) Appl. No.: 15/042,104

(22) Filed: Feb. 11, 2016

Related U.S. Application Data
(60) Provisional application No. 62/116,209, filed on Feb. 13, 2015.

(51) Int. Cl. H04L 29/06; G06F 21/64; H04L 29/08

(52) U.S. Cl. CPC H04L 63/08; H04L 63/10; H04L 67/02; G06F 21/64

(57) ABSTRACT

A new approach is proposed that contemplates systems and methods to support verification of a user's authentication information across multiple websites/domains owned and/or operated by different entities, which share users during a single session. When the user attempts to login to a first website/domain, he/she is required to provide authentication information in addition to user-id/password. An authentication platform is configured to generate and communicate the additional authentication information to the user and verify the additional authentication information the user provided to the first website/domain. When the user later attempts to access a second/unrelated website/domain, the verified additional authentication information is provided by the first website/domain to the second website/domain in the form of a signed cookie. The second website/domain parses the cookie and provides the additional authentication information to the authentication platform for verification without requiring the user to input it again at the second website/domain.

### CROSS-REFERENCE TO RELATED APPLICATIONS

This application claims the benefit of U.S. Provisional Patent Application No. 62/116,209, filed Feb. 13, 2015, and entitled “Syncing Partial Authentication Across Multiple Domains Via An API,” which is incorporated herein in its entirety by reference.

### BACKGROUND

Security is one of the most important concerns and value propositions for websites/domains of online transaction and payment processing companies as their customers and partners alike rely on them to keep sensitive information, such as credit card and social security numbers, secure. One way to address this security problem by the online transaction and payment processing companies in the past is to only collect the sensitive information on their own websites/domains where they can ensure security of such information because they have complete control over their domains. In order to support additional use-cases and applications, however, the online transaction and payment processing companies often need to provide services through their partners, which means that much of the sensitive information may be collected on their partners' websites/domains and then passed to them e.g., via API calls. Although the online transaction and payment processing companies cannot guarantee security of their partners' domains or servers, they can provide security services/features and APIs that will make it easier for their partners to implement a secure system.

One of such security services is Multi-factor Authentication (MFA), which is a security best practice that requires an additional form of authentication in addition to user-id/password to verify a user. This additional verification generally happens during user login (before or after the user has successfully entered their username/email and password combination), but can also be done to verify the user before certain enhanced operations (such as updating privacy/security settings). The additional authentication information typically relies on the user's ability to obtain a temporary verification code (e.g., MFA code, such as a PIN or a token), which can be communicated to the user via an email, a Short Message System (SMS) message sent to a previously verified phone number of the user, or an authentication application such as a Google Authenticator app. The user may then provide the verification code to the authenticating site to verify his/her identity.

In practice, different websites/domains may share users among them and sometimes those users will need to go through flows (i.e., a series of steps on multiple pages or URLs), which can be cross-domain; i.e., the flows include web pages on multiple websites/domains. Since the user may need to access services provided on the multiple websites/domains, it is desirable that the user is required to perform the additional authentication step (e.g., inputting the verification code) only once while visiting the multiple websites/domains.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support cross-domain user authentication in accordance with some embodiments.

FIG. 2 depicts an example of a flowchart of a process to support cross-domain user authentication in accordance with some embodiments.

FIG. 3 depicts a non-limiting example to illustrate the authentication flow when the first website/domain also includes the authentication platform in accordance with some embodiments.

FIG. 4 depicts a non-limiting example to illustrate the authentication flow when the second website/domain also includes the authentication platform in accordance with some embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support verification of a user's authentication information across multiple websites/domains owned and/or operated by different entities, which share users during a single session. When the user attempts to login to a first website/domain, he/she is required to provide authentication information in addition to user-id/password. An authentication platform is configured to generate and communicate the additional authentication information to the user and verify the additional authentication information the user provided to the first website/domain. When the user later attempts to access a second/unrelated website/domain, the verified additional authentication information is provided by the first website/domain to the second website/domain in the form of a signed cookie. The second website/domain parses the cookie and provides the additional authentication information to the authentication platform for verification without requiring the user to input it again at the second website/domain.

By maintaining and communicating the additional authentication information across multiple different websites/domains and allowing the websites/domains to share information about the authentication state of the user in the form of a cookie, the proposed approach enables the user to authenticate him/herself only once (instead of once per website/domain visit) during a single session to access multiple websites/domains. For a non-limiting example, the user may start on an online payment processing site, go to its partner's website, and then return to the online payment processing site wherein the user only needs to input additional authentication information once at the first site instead of twice (at both sites) in quick succession. The authentication platform not only simplifies the authentication process of the user across multiple websites/domains, it also makes it easier and more secure to maintain and verify the authentication information (in addition to user-id/password) for the user via a separate user identification verification mechanism.

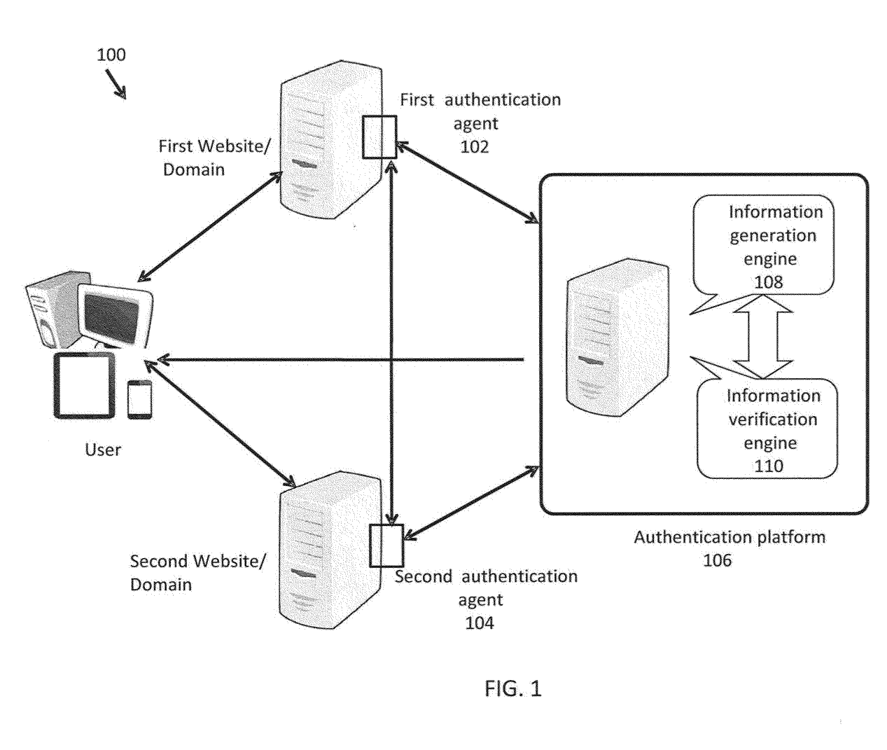

FIG. 1 depicts an example of a system diagram to support cross-domain user authentication. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein multiple hosts can be connected by one or more networks.

In the example of FIG. 1, the system 100 includes at least a first authentication agent 102 running on a (web) server of a first website/domain, a second authentication agent 104 running on a (web) server a second website/domain, a authentication platform 106 which further includes an information generation engine 108 and an information verification engine 110. As used herein, each of the agents and engines will typically include software instructions that are stored in a storage unit such as a non-volatile memory (also referred to as secondary memory) of a computing unit/appliance/host for practicing one or more processes. When the software instructions are executed, at least a subset of the software instructions is loaded into memory (also referred to as primary memory) by one of the hosts of the computing unit, which becomes a special purposed one for practicing the processes. The processes may also be at least partially embodied in the host into which computer program code is loaded and/or executed, such that, the host becomes a special purpose computing unit for practicing the processes. When implemented on a general-purpose computing unit, the computer program code segments configure the computing unit to create specific logic circuits.

In the example of FIG. 1, each of the first and the second websites/domains and the authentication platform 106 runs on a host, which can be either a physical server residing locally or a virtual server hosted by remote servers in a cloud. Here, the host 102 can be a computing device, a communication device, a storage device, or any microprocessor system, microprocessor-based or programmable consumer electronics, minicomputer, mainframe computer capable of running a software component. For non-limiting examples, a computing device can be but is not limited to a laptop PC, a desktop PC, a tablet PC, or a server running Linux or other operating systems.

The user of the system 100 may access the first and the second websites/domains via a computing device, which can be but is not limited to, a mobile/hand-held device such as a tablet, an iPhone, an iPad, an Android-based device, and/or other types of mobile communication device, a PC, such as a laptop PC and a desktop PC, and a server machine. Each of the hosts and the computing device has a communication interface (not shown), which enables them to communicate with each other following certain communication protocols, such as TCP/IP, http, https, ftp, and sftp protocols, over one or more communication networks (not shown). The communication networks can be but are not limited to, internet, intranet, wide area network (WAN), local area network (LAN), wireless network, Bluetooth, WiFi, and mobile communication network. The physical connections of the network and the communication protocols are well known to those of skill in the art.

In the example of FIG. 1, when a user attempts to login to the first web site/domain, he/she must enter his/her login name (user id or email) and a password. Due to the sensitive nature of the contents/services the user is requesting to access on the first website/domain, additional authentication of/challenge to the user's identity is required. In some embodiments, the first authentication agent 102 is configured to prompt the user to enter one or more additional pieces of authentication information (e.g., the MFA code discussed above) on the first website/domain. In some embodiments, the first authentication agent 102 is further configured to ask the user for his/her preferred way to receive such additional authentication information (e.g., via email or a SMS message). The first authentication agent 102 is then configured to send a request for the additional authentication information to the authentication platform 106. Here, the request may also include the user's identification information (e.g., user id, phone number or email address) and his/her preferred means/way to receive the additional authentication information, e.g., an email address if the user prefers to receive the information via an email or a mobile phone number if the user prefers to receive the information via an SMS message. In some embodiments, the first authentication agent 102 is configured to send the request by invoking an Application Program Interface (API) provided by the authentication platform 106 as part of an authentication service.

Upon receiving the request for the additional authentication from the first authentication agent 102, the information generation engine 108 of the authentication platform 106 is configured to generate the additional authentication information and provide it to the user via his/her preferred way of communication (e.g., email or SMS message) as specified in the request. After the user enters the additional authentication information received from the authentication platform 106 at the first website/domain, the first authentication agent 102 is configured to provide the information entered by the user to the authentication platform 106 for verification via, for a non-limiting example, an API call for such verification to the authentication platform 106.

Once the additional information entered to the first website/domain is received, the information verification engine 110 of the authentication platform 106 is configured to compare the received information with the additional authentication information it provided to the user. If the two match, then the user's identification is verified/authenticated. The information verification engine 110 is then configured to save a state of whether the user has been verified via the additional authentication information in the current session in a cookie cryptographically signed by the authentication platform 106. Here, the cookie can be easily transmitted between the websites/domains so that the user can be easily verified on future requests to the sites. Additionally, since it is cryptographically signed, the contents/payload of the cookie cannot be tampered with without breaking the key/signature. The information verification engine 110 is then configured to return the signed cookie back to the first authentication agent 102, e.g., as one of the returning parameters of the API (e.g., a HTTP GET parameter), wherein the first authentication agent 102 is configured to store the signed cookie for the user (under the name or id of the user) on the first website/domain.

When the user is done with his/her current work on the first website/domain and attempts to access/login to a second website/domain, he/she is redirected to the second website/domain, wherein the first authentication agent 102 is configured to include the signed cookie of the user as a parameter of the redirect link/URL. Note that the signed cookie is not domain-specific, i.e., it can be accessed and read by a website/domain (e.g., the second website/domain) other than the first website/domain, thus enabling cross-domain flow and sharing of authentication information. Once the second authentication agent 104 at the second website/domain receives the signed cookie from the first authentication agent 102, it is configured to parse the signed cookie to retrieve the additional authentication information previously used to authenticate the user at the first website/domain. The second authentication agent 104 is then configured to provide the parsed additional authentication information to the authentication platform 106 for verification via, for a non-limiting example, an API call to the authentication platform 106.

Once the additional information from the signed cookie of the user is received from the second authentication agent 104, the information verification engine 110 of the authentication platform 106 is configured to verify the received information with the additional authentication information it provided to the user for authentication to the first website/domain. If the two match, the information verification engine 110 is then configured to confirm/authenticate the user's identity to the second authentication agent 104. Since the second authentication agent 104 trusts the user authentication by the authentication platform 106, it allows the user to access its contents and services without prompting the user to enter any additional authentication information on the second website/domain. Note that although the websites/domains can pass the signed cookie between them over an untrusted channel (e.g., browser redirects), the cookie is always verified via a trusted channel (e.g., a server to server API call). Even though the cookie is signed, it is still important to validate the cookie via the trusted channel in order to eliminate the possibility of spoofing.

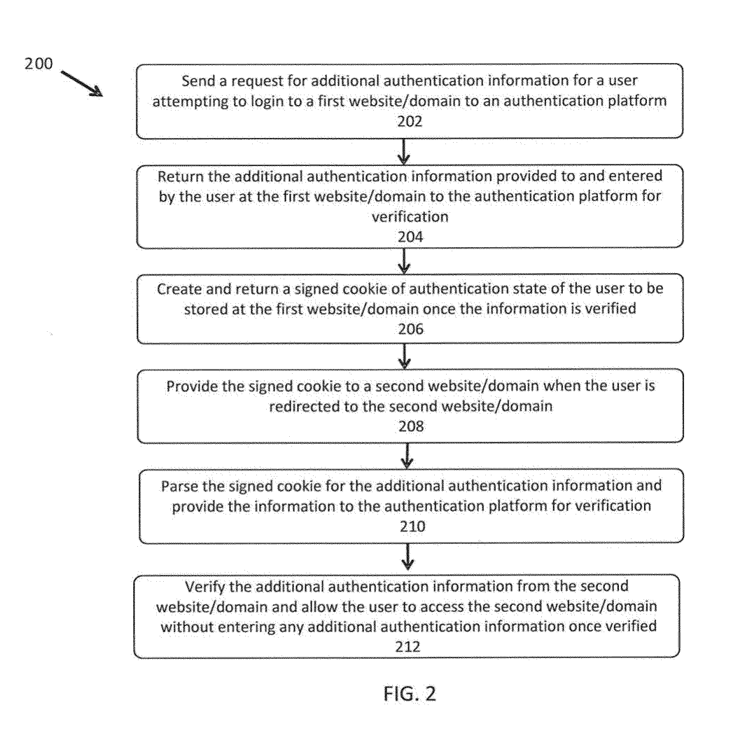

FIG. 2 depicts an example of a flowchart 200 of a process to support cross-domain user authentication. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

The flowchart 200 starts at step 202, where a request for additional authentication information for a user logging in to a first website/domain is sent to an authentication platform. The flowchart 200 continues to step 204, where the additional authentication information provided to the user and entered by the user at the first website/domain is returned to the authentication platform for verification. The flowchart 200 continues to step 206, where a signed cookie is created, returned to, and stored at the first website/domain once the additional authentication information is verified. The flowchart 200 continues to step 208, where the signed cookie is provided to a second website/domain when the user is redirected to the second website/domain. The flowchart 200 continues to step 210, where the signed cookie is parsed for the additional authentication information, which is then provided to the authentication platform for authentication. The flowchart 200 ends at step 212, where the additional authentication information is verified by the authentication platform and the user is allowed to access the second website/domain without being prompted to enter any additional authentication information.

In some embodiments, the first or the second website/domain and its associated authentication agent may be owned as operated by the same entity as the authentication platform 106. Under such scenario, the authentication platform 106 may reside on the same host/server/domain or within the same intranet as the first or the second website/domain and its associated authentication agent as discussed in the following two cases (wherein the user need to provide the additional authentication step only once in both cases):

### Case 1: the First Website/Domain Also Includes the Authentication Platform 106

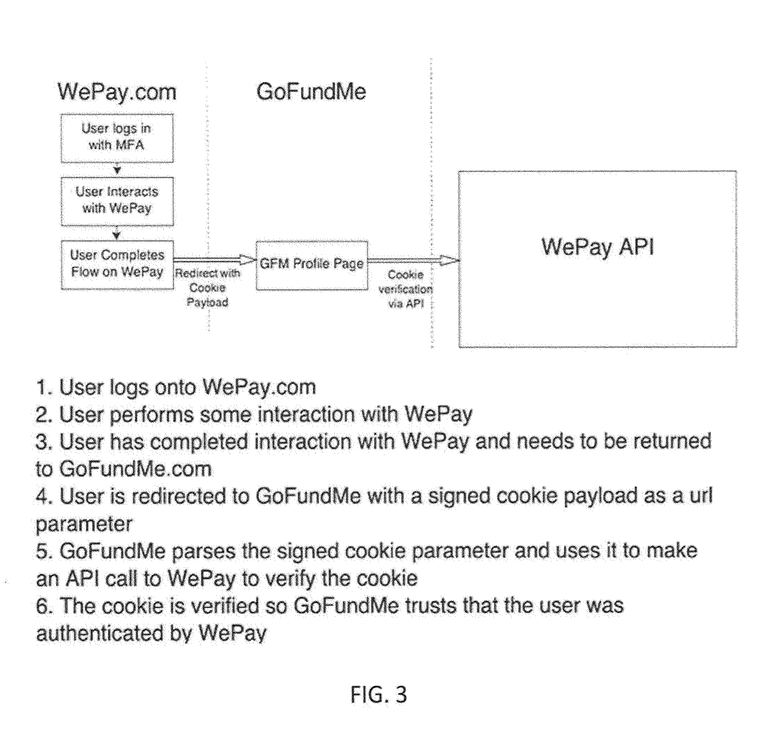

In this case, the first website/domain allows the user to directly verify and authenticate him/herself on its website. It also allows the second website/domain to make use of the authentication platform 106 on the first website/domain (e.g., via an API) to authenticate the user on the second website/domain as well. Specifically, once the user is done on the first website/domain and is redirected to the second website/domain, the first authentication agent 102 will include a signed cookie as a GET parameter in the HTTP request. Upon receiving this cookie parameter, the second authentication agent 104 is configured to parse the signed cookie and verify its legitimacy via an API call to the authentication platform 106 at the first website/domain. Once it is verified that the user's identity has been authenticated by the first website/domain, the second authentication agent 104 sets and stores that cookie for the user in order to verify its identity in his/her future visits to the second website/domain without prompting the user for any additional authentication information. FIG. 3 depicts a non-limiting example to illustrate the authentication flow when the first website/domain also includes the authentication platform 106. In the example of FIG. 3, the user starts at WePay.com, which is a non-limiting example of the first website/domain, and is later redirected to GoFundMe (a partner site of WePay.com), which is a non-limiting example of the second website/domain, and WePay API is a non-limiting example of the authentication platform 106 co-resides on WePay.com.

### Case 2: the Second Website/Domain Also Includes the Authentication Platform 106

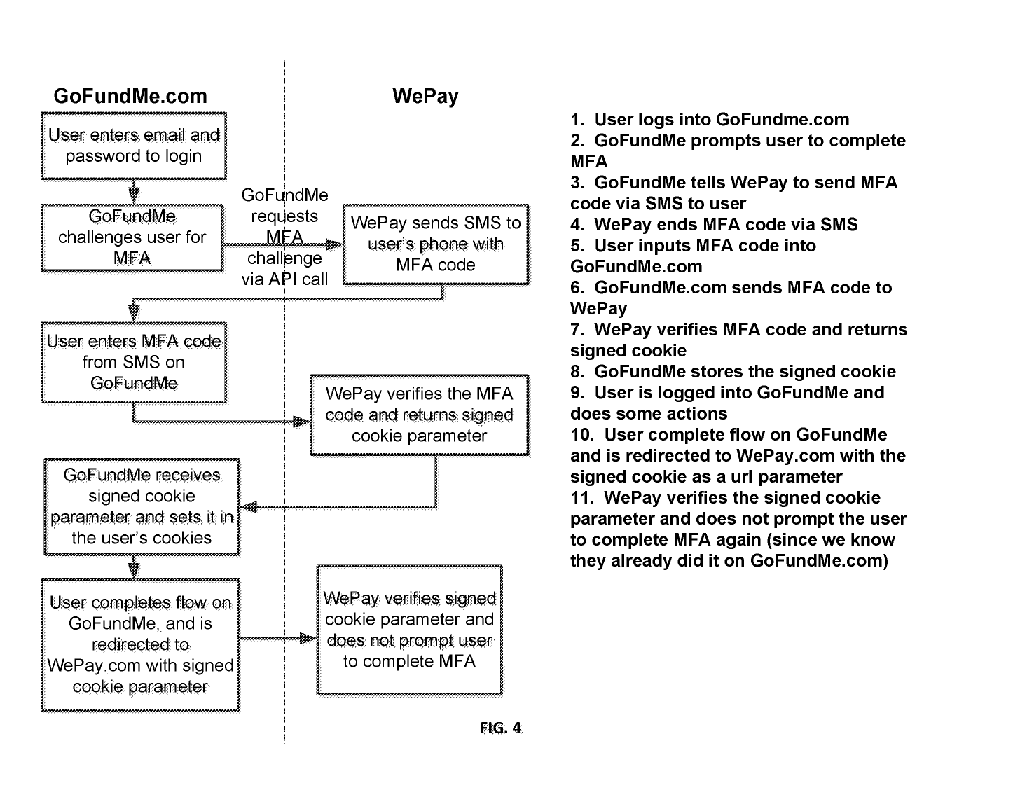

In this case, once the user is provided with and enters the additional authentication information at the first website/domain, the first authentication agent 102 is configured to authenticate the user by invoking an API call to the authentication platform 106 at the second website/domain. The authentication platform 106 verifies the additional authentication information and returns a signed cookie in the API call to the first web site/domain for authentication of the user at the first web site/domain. The first authentication agent 102 stores the signed cookie for the user and when the user is later redirected to the second website/domain, it includes the signed cookie as a GET parameter in the redirect HTTP request. The second authentication agent 104 then verifies the authenticity of the signed cookie easily via its co-residing authentication platform 106, which creates the signed cookie in the first place, and stores the signed cookie for the user's future visits to the second website/domain without prompting the user for any additional authentication information. FIG. 4 depicts a non-limiting example to illustrate the authentication flow when the second website/domain also includes the authentication platform 106. In the example of FIG. 4, the user starts at GoFundMe (a partner site of WePay.com), which is a non-limiting example of the first website/domain, and is later redirected to WePay.com, which is a non-limiting example of the second website/domain.

In both cases above, the content/payload of the cookie sent between the first and the second websites/domains (e.g., over HTTP GET) is cryptographically signed so that it cannot be tampered with. Additionally, the cookie itself can also be cryptographically signed (i.e., the “signed cookies”) using the same algorithm and/or keys. In some embodiments, a pre-shared key (PSK) known only by the first and the second websites/domains (and the authentication platform 106 included in one of them) can be used as a “salt” when hashing the data to generate a signature/key to sign/encrypt/decrypt the signed cookie and its content. Here, for a non-limiting example, the PSK can be a client ID or secret assigned to one of the websites/domains, e.g., the partner site. Specifically, the PSK allows the first website/domain to cryptographically-sign the payload/cookie (producing a one-way hash) and only the first and the second websites/domains are able to validate the signature (by re-hashing the data and comparing the signatures), which makes the payload tamper-proof. Before either of the websites/domains can take action on the data/payload of the cookie, the signature of the signed cookie is first verified. If the signatures do not match, it means that the cookie has been compromised and the exchange of the additional authentication information is abandoned. Under these circumstances, re-authentication of the user is required.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system to support cross-domain user authentication, comprising:
a first authentication agent associated with a first website/domain, which in operation, is configured to
send a request for additional authentication information for a user attempting to login to the first website/domain to an authentication platform;
return the additional authentication information provided to and entered by the user at the first website/domain to the authentication platform for verification;
provide a signed cookie of authentication state of the user to a second web site/domain when the user is redirected to the second website/domain;
a second authentication agent associated with said second website/domain, which in operation, is configured to
parse the signed cookie for the additional authentication information and provide the additional authentication information to the authentication platform for verification;
said authentication platform running on a computing unit, which in operation, is configured to
create and return the signed cookie to be stored at the first website/domain once the additional authentication information received from the first website/domain is verified;
verify the additional authentication information from the second website/domain and allow the user to access the second website/domain without entering any additional authentication information once verified.

2. The system of claim 1, wherein:
the additional authentication information is a Multi-factor Authentication (MFA) code.

3. The system of claim 1, wherein:
the user is required to enter the additional authentication information only once.

4. The system of claim 1, wherein:
the first authentication agent is configured to
prompt the user to enter the additional authentication information on the first website/domain;
ask the user for his/her preferred way to receive the additional authentication information.

5. The system of claim 4, wherein:
the authentication platform is configured to generate the additional authentication information and provide it to the user via his/her preferred way of communication as specified in the request.

6. The system of claim 1, wherein:
the first authentication agent is configured to send the request by invoking an Application Program Interface (API) provided by the authentication platform as part of an authentication service.

7. The system of claim 1, wherein:
the first authentication agent is configured to return the additional authentication information to the authentication platform via an API call.

8. The system of claim 7, wherein:
the authentication platform is configured to return the signed cookie as one of the returning parameters/payload of the API call.

9. The system of claim 1, wherein:
the authentication platform is configured to verify and authenticate the user at the first website/domain by comparing the received information with the additional authentication information it provided to the user.

10. The system of claim 1, wherein:
the cookie is cryptographically signed so that its content cannot be tampered with without breaking the signature.

11. The system of claim 1, wherein:
the signed cookie is not domain-specific and is accessible by a website/domain other than the first website/domain.

12. The system of claim 1, wherein:
the first authentication agent is configured to include the signed cookie as a parameter of the redirect link/URL.

13. The system of claim 1, wherein:
the first website/domain also includes the authentication platform, wherein the first website/domain is configured to
allow the user to directly verify and authenticate him/herself on its web site;
allow the second website/domain to make use of the authentication platform on the first website/domain via an API to authenticate the user on the second web site/domain as well.

14. The system of claim 1, wherein:
the second website/domain also includes the authentication platform, wherein the first authentication agent is configured to
authenticate the user by invoking an API call to the authentication platform at the second website/domain;
store the signed cookie for the user and include the signed cookie as a GET parameter in the redirect HTTP request when the user is later redirected to the second website/domain.

15. A computer-implemented method to support cross-domain user authentication, comprising:
sending a request for additional authentication information for a user attempting to login to a first website/domain to an authentication platform;
returning the additional authentication information provided to and entered by the user at the first website/domain to the authentication platform for verification;
creating and returning a signed cookie of authentication state of the user to be stored at the first website/domain once the additional authentication information received from the first website/domain is verified;
providing the signed cookie to a second website/domain when the user is redirected to the second website/domain;
parsing the signed cookie for the additional authentication information and providing the additional authentication information to the authentication platform for verification;
verifying the additional authentication information from the second website/domain by the authentication platform and allowing the user to access the second website/domain without entering any additional authentication information once verified.

16. The computer-implemented method of claim 15, wherein:
the user is required to enter the additional authentication information only once.

17. The computer-implemented method of claim 15, wherein:
the signed cookie is not domain-specific and is accessible by a website/domain other than the first website/domain.

18. The computer-implemented method of claim 15, further comprising:
prompting the user to enter the additional authentication information on the first web site/domain;
asking the user for his/her preferred way to receive the additional authentication information.

19. The computer-implemented method of claim 18, further comprising:
generating the additional authentication information and provide it to the user via his/her preferred way of communication as specified in the request.

20. The computer-implemented method of claim 15, further comprising:
sending the request by invoking an Application Program Interface (API) provided by the authentication platform as part of an authentication service.

21. The computer-implemented method of claim 15, further comprising:
returning the additional authentication information to the authentication platform via an API call;
returning the signed cookie as one of the returning parameters/payload of the API call.

22. The computer-implemented method of claim 15, further comprising:
verifying and authenticating the user at the first website/domain by comparing the received information with the additional authentication information it provided to the user.

23. The computer-implemented method of claim 15, further comprising:
cryptographically signing the cookie so that its content cannot be tampered with without breaking the signature.

24. The computer-implemented method of claim 15, further comprising:
including the signed cookie as a parameter of the redirect link/URL.

25. The computer-implemented method of claim 15, further comprising:
including the authentication platform with the first website/domain, wherein the first website/domain is configured to
allow the user to directly verify and authenticate him/herself on its website;
allow the second website/domain to make use of the authentication platform on the first website/domain via an API to authenticate the user on the second web site/domain as well.

26. The computer-implemented method of claim 15, further comprising:
including the authentication platform with the second website/domain, wherein the first website/domain is configured to
authenticate the user by invoking an API call to the authentication platform at the second website/domain;
store the signed cookie for the user and include the signed cookie as a GET parameter in the redirect HTTP request when the user is later redirected to the second website/domain.
